(19) United States
(12) Patent Application Publication
(10) Pub. No.: US 2016/0122525 A1
(43) Pub. Date: May 5, 2016

(54) COMPOSITE SYSTEM WITH HIGH IMPACT STRENGTH AND A HIGH SOFTENING POINT

(71) Applicants: Gerald DIETRICH, Alsbach-Hähnlein (DE); Michael WICKER, Seeheim-Jugenheim (DE); Chin-Lung CHEN, Taipei City (TW); EVONIK RÖHM GMBH, Darmstadt (DE)

(72) Inventors: Rüdiger CARLOFF, Darmstadt (DE); Gerald DIETRICH, Alsbach-Haehnlein (DE); Michael WICKER, Seeheim-Jugenheim (DE); Chih-Lung CHEN, Taipei City (TW)

(73) Assignee: Evonik Roehm GmbH, Darmstadt (DE)

(21) Appl. No.: 14/891,898

(22) PCT Filed: May 24, 2013
(86) PCT No.: PCT/EP13/60702

§ 371 Date: Nov. 17, 2015

(51) Int. Cl. C08L 35/06; B32B 27/30; C08L 33/12

(52) U.S. Cl. CPC C08L 35/06; C08L 33/12; B32B 27/302; B32B 27/308

(57) ABSTRACT

The present invention relates to a composite system, preferably a multilayer film, having high impact resistance and heat distortion resistance, and to a process for production thereof and to the use thereof.

The present invention relates to a composite system, preferably a multilayer film, having high impact resistance and heat distortion resistance, and to a process for production thereof and to the use thereof.

### STATE OF THE ART

Composite systems, preferably multilayer films, are used in display front panels, in mobile displays, for example in portable telephones, smartphones, and input terminals, and in display panels. In addition, composite systems, preferably multilayer films, are used as automotive glazing, automobile bodies, in games consoles and in carports.

Various embodiments of composite systems formed from various polymer types are known. Important requirements are good impact resistance, high optical transparency and good surface hardness. In addition, high scratch resistance should be present. In the case of use of composite systems, preferably multilayer films, low warpage of the multilayer film at high temperatures and high air humidity is also an important property.

When a composite system or a multilayer film is used as a front panel in displays, the composite system or the multilayer film sits in front of the actual display unit, for example an OLED (organic light emitting diode) or an LCD panel (liquid-crystal display). The composite system or the multilayer film should lie flat on these display units. Distortion of the composite system or of the multilayer film by environmental influences is therefore unwanted, since pressure is then exerted on the LCD unit beneath, which leads to strong color structures.

The distortion or warpage of a composite system or of a multilayer film during use can be attributed to causes including an excessively high operating temperature or ambient temperature.

In order to increase the impact resistance of the composite/film, one layer of the composite/film may consist, for example, of polycarbonate (PC). Polycarbonate layers or films feature high impact resistance and high heat distortion resistance. A disadvantage of polycarbonate is, however, the low surface hardness and scratch resistance thereof. In order to increase the scratch resistance and surface hardness, PC can be laminated with polymethyl methacrylate (PMMA).

Polymethylmethacrylate (PMMA) generally has higher surface hardness than polycarbonate and is known to have very good weathering stability which can also be used as protection for the polycarbonate.

Through lamination of PC with polymethyl methacrylate, the multilayer film obtained or the composite has high impact resistance and high surface hardness on the PMMA side. However, the heat distortion resistance of the PMMA is frequently much lower compared to the PC, and so there is warpage of the film/composite at relatively high temperatures.

In the prior art, it is known that the warpage can be countered by raising the heat distortion resistance of the PMMA layer, for example JP 2009 196125A.

By way of example, JP 2009 196125A describes a multilayer composed of a layer of polymethacrylate copolymer and a polycarbonate layer for display applications. In order to increase the heat distortion resistance of the polymethacrylate, a specific polymethacrylate copolymer is described. The polymethacrylate copolymer is a copolymer of a (meth)acrylate and a cyclic vinyl monomer. The example of JP 2009 196125A mentions vinylcyclohexane.

It is also known that the preparation of a polymethacrylate—as described in JP 2009 196125A—is very complex, since the cyclic vinyl monomers claimed do not have good free-radical polymerizability with other (meth)acrylates.

The free-radical copolymerization of free-radically polymerizable monomers such as (meth)acrylates is a simple known and inexpensive method for preparation of, for example, polymethacrylates.

EP 168 0276B1 describes a multilayer film composed of polycarbonate and a polymethacrylate, with cyclohexyl methacrylate as a comonomer in the polymethacrylate. The polymethacrylate with cyclohexyl methacrylate, because of the cyclic ester group, has better compatibility with PC compared to a standard PMMA. However, the heat distortion resistance of the polymethacrylate is not increased significantly by the cyclohexyl methacrylate.

Furthermore, it is known from DE 44 40 219A1, that a copolymer obtained from the copolymerization of methyl methacrylate and styrene and maleic anhydride increases the heat distortion resistance. The methyl methacrylate-styrene-maleic anhydride copolymers known according to DE 44 40 219A1 exhibit a high heat distortion resistance, but high warpage levels are attained in the case of lamination onto PC.

### Problem and Solution

In view of the prior art cited and discussed herein, the problem addressed by the present invention was therefore that of developing a composite system, preferably a multilayer film, which is easily producible, exhibits good impact resistance and lower warpage at relatively high temperatures than a multilayer film, known in the prior art, formed from polycarbonate and a standard PMMA, but a high heat distortion resistance, as known according to DE 44 40 219A1 is simultaneously achieved.

A further problem was that of providing a composite system or a multilayer film according to the above requirements, which likewise has good adhesion within the composite system or the multilayer film, i.e. good adhesion between the individual layers.

An additional problem was to configure the composite system or the multilayer film such that the outer sides or layers of the composite system or of the multilayer film can each be coated with a functional coating material.

These objects, and further objects which are not stated explicitly but can be inferred from the connections discussed herein or are apparent from these, are surprisingly solved by a composite system comprising:
a) a polymer blend layer comprising or consisting of
   A) a (meth)acrylate (co)polymer or a mixture of (meth)acrylate (co)polymers and
   B) a styrene-maleic anhydride (co)polymer,
   wherein the proportion of repeat maleic anhydride units in the styrene-maleic anhydride (co)polymer B) is 10 to 30% by weight, preferably 15 to 28% by weight, more preferably 20 to 26% by weight, based on the total weight of the styrene-maleic anhydride (co)polymer B), and
   wherein the proportion of repeat maleic anhydride units in the polymer blend layer a) is 1 to 27% by weight, preferably 1.5 to 25% by weight, more preferably 2 to 23% by weight, based on the total weight of the polymer blend layer a), and
   wherein the styrene-maleic anhydride (co)polymer B) has been prepared from a monomer mixture comprising styrene, maleic anhydride and 0 to 50% by weight of vinyl monomers copolymerizable with styrene and/or maleic anhydride, based on the total weight of maleic anhydride in the styrene-maleic anhydride (co)polymer B),
b) optionally one or more adhesive layers, glass layers and/or optical films, preferably one or more adhesive layers, more preferably at least one adhesive layer of an optical clear adhesive (OCA) or of a pressure-sensitive adhesive (PSA), and
c) a glass or polymer layer, preferably a polymer layer, more preferably a polycarbonate layer,
wherein a) and c) are bonded to one another or the one or more layers b) bond the two layers a) and c) to one another.

The monomer mixture from which the styrene-maleic anhydride (co)polymer B) is prepared may comprise, as well as styrene, maleic anhydride and 0 to 50% by weight of vinyl monomers copolymerizable with styrene and/or maleic anhydride, based on the total weight of maleic anhydride in the styrene-maleic anhydride (co)polymer B), further constituents, for example additives.

For a particular embodiment of the present invention, the monomer mixture from which the styrene-maleic anhydride (co)polymer B) is prepared consists of styrene, maleic anhydride and 0 to 50% by weight of vinyl monomers copolymerizable with styrene and/or maleic anhydride, based on the total weight of maleic anhydride in the styrene-maleic anhydride (co)polymer B).

It has been found that, surprisingly, through the production of a blend from a (meth)acrylate (co)polymer or a mixture of (meth)acrylate (co)polymers A) and a styrene-maleic anhydride (co)polymer B) according to the above details and subsequent application, preferably lamination, to a glass or polymer layer, preferably a polycarbonate layer, firstly the heat distortion resistance of the PMMA is increased to a comparable degree to that by production of a copolymer from methyl methacrylate (MMA) and maleic anhydride and styrene, and secondly the requirements for good compatibility with the polymer or glass layer, preferably the polycarbonate layer, are fulfilled, and, moreover, lower warpage of the composite, preferably of the laminate, is achieved than was known and to be expected from the prior art with known composite systems or laminates.

(Meth)Acrylate (Co)Polymer or Mixture of (Meth)Acrylate (Co)Polymers A)=Polymer A)

The polymers described according to A) are generally obtained by free-radical polymerization of mixtures comprising methyl methacrylate. In general, these mixtures comprise at least 30% by weight, preferably at least 50% by weight, more preferably at least 80% by weight, further preferably at least 90% by weight and most preferably at least 95% by weight, based on the weight of the monomers, of methyl methacrylate. A particularly high quality is exhibited especially by polymers consisting essentially of polymethyl methacrylate.

In addition, these mixtures for obtaining the polymers A) may comprise further (meth)acrylates copolymerizable with methyl methacrylate. The expression “(meth)acrylates” encompasses methacrylates and acrylates and mixtures of the two.

According to the invention, the compositions to be polymerized as well as the above (meth)acrylates, may also include further unsaturated monomers copolymerizable with methyl methacrylate and the aforementioned (meth)acrylates. These include alkyl(meth)acrylates, methyl acrylate, ethyl acrylate, butyl acrylate, cyclohexyl(meth)acrylate, norbornyl(meth)acrylate, styrene, substituted styrenes, vinylcyclohexane, vinyl acetate, (meth)acrylic acid, glutaric anhydride, maleic anhydride, n-isopropyl(meth)acrylamide, (meth)acrylamide and acrylonitrile. Preferably, in the mixtures for obtaining the polymers A), the (meth)acrylic acid, glutaric anhydride, maleic anhydride, n-isopropyl(meth)acrylamide, (meth)acrylamide and acrylonitrile comonomers, aside from the further abovementioned monomers, are present only in a total proportion by weight of max. 8% by weight, based on the proportion by weight of the styrene-maleic anhydride (co)polymer B) in the polymer blend layer a).

The repeat vinylcyclohexane units in the polymer A) can also be obtained by hydrogenating the benzene ring of a methyl methacrylate-styrene copolymer, since vinylcyclohexane can be free-radically copolymerized only inefficiently with methyl methacrylate. All monomers listed are preferably used in a high purity.

In addition, polymer A) may be a blend of various polymers of type A).

The weight-average of the mean molecular weight M_{w} of polymer A) is preferably between 50 000 and 500 000 g/mol, more preferably between 60 000 and 300 000 g/mol and especially preferably between 80 000 and 200 000 g/mol, without any intention that this should impose a restriction.

Styrene-Maleic Anhydride (Co)Polymer B)=Polymer B)

The inventive composite system is preferably characterized in that the styrene-maleic anhydride (co)polymer B) has a proportion of repeat styrene units of 55 to 90% by weight, preferably 58 to 85% by weight, more preferably 61 to 80% by weight, based on the total weight of the styrene-maleic anhydride (co)polymer B).

If the styrene-maleic anhydride (co)polymer B) in an inventive composite system has been prepared from a monomer mixture comprising up to 50% by weight of vinyl monomers copolymerizable with styrene and/or maleic anhydride, based on the total weight of maleic anhydride in the styrene-maleic anhydride (co)polymer B), these vinyl monomers are preferably selected from the group consisting of methyl(meth)acrylate, alkyl(meth)acrylates, methyl acrylate, ethyl acrylate, butyl acrylate, cyclohexyl(meth)acrylates, norbornyl(meth)acrylates, vinylcyclohexanes.

The weight-average molecular weight M_{w} of the styrene-maleic anhydride (co)polymer B) for use in accordance with the invention may vary within wide ranges, the molecular weight typically being matched to the end use and the processing method. In general, however, it is in the range between 40 000 and 500 000 g/mol, preferably 50 000 to 300 000 g/mol and more preferably 70 000 to 150 000 g/mol, without any intention that this should impose a restriction.

In a preferred embodiment of the inventive composite system, the styrene-maleic anhydride (co)polymer B) has a mean molecular weight of at least M_{w}=70 000 g/mol.

The styrene-maleic anhydride (co)polymer B) according to the present invention, has preferably been prepared by a process which is elucidated hereinafter in the description of the inventive example.

Polymer Blend Layer a)

The polymer blends a) used for production of the composite system produced in accordance with the invention are preferably polymer mixtures of a (meth)acrylate (co)polymer or a mixture of (meth)acrylate (co)polymers A) (=polymer A)) and a styrene-maleic anhydride (co)polymer B) (=polymer B)), the thermoplastic main constituent of the (meth)acrylate (co)polymer or the mixture of (meth)acrylate (co)polymers A) (=polymer A)) consisting to an extent of at least 30% by weight, preferably at least 50% by weight, of repeat methyl methacrylate units. It is further preferable that the thermoplastic main constituent of the (meth)acrylate (co)polymer or of the mixture of (meth)acrylate (co)polymers A) (=polymer A)) consists to an extent of at least 80% by weight, preferably at least 90% by weight and more preferably to an extent of at least 95% by weight, of repeat methyl methacrylate units.

A preferred polymer blend layer a) is in some cases also referred to in the context of the invention as “modified PMMA according to the invention”.

In a preferred inventive composite system, a composition of which the polymer blend layer a) is composed has a Vicat softening temperature VET (ISO 306-B50) of at least 110° C., preferably of at least 112° C., more preferably of at least 115° C.

A further inventive embodiment of the composite system is characterized in that the polymer blend layer a) has a thickness in the range from 10 to 2000 μm, preferably from 20 to 1500 μm, more preferably from 30 to 1000 μm, further preferably from 40 to 500 μm, most preferably from 50 to 300 μm.

A further embodiment of the invention is a composite system, preferably according to one of the above preferred embodiments, in which the polymer blend layer a) comprises customary additions or additives. These include UV stabilizers, UV absorbers, lubricants, antistats, flame retardants, additives for increasing scratch resistance, antioxidants, light stabilizers, organic phosphorus compounds, weathering stabilizers and/or plasticizers.

It is further preferable that these additions or additives present in the polymer blend layer a) of the inventive composite system are each present in a proportion of 0.001 to 5% by weight, preferably each in a proportion of 0.001 to 1% by weight, further preferably each in a proportion of 0.002 to 0.5% by weight, especially preferably each in a proportion of 0.005 to 0.2% by weight, based in each case on the total weight of the polymer blend layer a). The amount of additions or additives should be fixed according to the end use. Preferably, a polymer blend layer a) of an inventive composite system comprises a total of at most 5% by weight, preferably a total of at most 2% by weight, of additives, based on the total weight of the polymer blend layer a).

The UV stabilizers are preferably sterically hindered amines (hindered amine light stabilizers; HALS) and methyl salicylates.

The UV absorbers are preferably sterically hindered phenols, especially benzotriazoles, for example hydroxyphenylbenzotriazoles, and/or triazines. However, it is also possible to use substituted benzophenones, salicylic esters, cinnamic esters, oxalanilides, benzoxazinones or benzylidene malonate.

Preferred lubricants are fatty acids, fatty acid esters or fatty alcohols, for example stearic acid, palmitic acid, stearyl alcohol, cetyl alcohol and technical mixtures thereof.

Preferred antistats are, for example, laurylamine ethoxylate and glyceryl monostearate.

Additives for increasing scratch resistance are, for example, polyorganosiloxanes.

In a composite system particularly preferred in accordance with the invention, a weight ratio of the (meth)acrylate (co)polymer or of the mixture of (meth)acrylate (co)polymers A) (=polymer A)) to the styrene-maleic anhydride (co)polymer B) (=polymer B) in the range from 10:90 to 90:10, preferably in the range from 15:85 to 85:15, more preferably in the range from 20:80 to 80:20, very preferably from 70:30 to 30:70, is present.

The polymer blend layer a) of an inventive composite system may optionally be impact-modified. Suitable impact modifiers which can be used in the context of the present invention are, for example, rubber particles containing crosslinked butadiene and/or styrene and/or crosslinked longer-chain alkyl(meth)acrylates. However, it may likewise be preferable in the context of the invention that both the polymer blend layer a) and all further constituents of the inventive composite system do not comprise any impact modifier. Impact modifiers could possibly disrupt the optical properties in one of the preferred uses of the inventive composite system, for example, as polymer glazing for displays.

Glass or Polymer Layer c)

It has been found to be advantageous in the context of the invention to use a thermoplastic polymer as layer c).

In a particularly preferred embodiment, the inventive composite system is characterized in that the layer c) is a polycarbonate layer.

Preferably in accordance with the invention, the polycarbonate component used is Makrolone 2607 from Bayer Materials (having an MVR of 12 ml/10 min (300° C./1.2 kg, to ISO 1133) and a Vicat temperature B50 of 143° C. to ISO 306). However, other polycarbonate types from Bayer Materials are also conceivable as the polycarbonate layer. Equally possible for use as the polycarbonate layer are also polycarbonates of the Calibre® type from Styron, Lexan® from Sabic, Tarfilone from Idemitsu, Panlite® from Tejin Kasei and further polycarbonates from other polycarbonate manufacturers.

The particularly preferred embodiment of the inventive composite system in which layer c) is a polycarbonate layer has given rise to particularly good results in terms of the properties of reduction of warpage and of provision of an impact-modified composite, combined with a high heat distortion resistance. Particular mention should be made of the fact that the polycarbonate layer is generally comparatively soft and the good impact resistance in combination with good surface hardness is only achieved through the composite. However, the combination of these properties is important for many of the desired applications, for example in display applications.

An especially preferred embodiment of the inventive composite system is one in which the outer polycarbonate layer c) and/or the outer polymer blend layer a) has been provided with a functional coating.

According to the invention, it is additionally preferable that the composite system, preferably according to one of the embodiments described above, is characterized in that layer c), which is further preferably a polycarbonate layer, has a thickness in the range from 20 to 3000 μm, preferably from 50 to 2000 μm, more preferably from 200 to 1500 μm, further preferably from 300 to 1200 μm.

Composite

It is further preferable in the context of the invention that, in an inventive composite system, especially a composite system in which layer c) is a polycarbonate layer, the polymer blend layer a) has been applied to the layer c), preferably by lamination.

Lamination in the context of the present invention can be effected by means of a coextrusion, i.e. by means of joining two layers a) and c), in the present invention preferably a PMMA-containing layer and a polycarbonate layer. However, the lamination is not restricted to coextrusion. Also suitable in the context of the invention, are other known processes for bonding two layers a) and c), preferably a PMMA-containing layer with a polycarbonate layer.

It is preferable in accordance with the invention that the composite system, preferably according to one of the above preferred embodiments, is a laminate, i.e. is present in the form of a laminate.

Moreover, it is especially preferable that the inventive composite system is a multilayer film, i.e. is present in the form of a multilayer film.

The inventive composite system may preferably be characterized in that a) and/or c) has functional coatings on one or both sides, preferably scratch-resistant coatings, anti-reflection coatings and/or antistatic coatings. According to the inventive teaching, the coatings may either each be the same or each be different from one another (for example embodiments where the single-sided or double-sided coatings of a) and c) are all scratch-resistant coatings, or embodiments where a) and c) each have only one coating and these coatings are different from one another, for example, one scratch-resistant and one antistatic coating). The invention encompasses all the possible combinations which arise from the fact that a) and/or c) may have functional coatings on one or both sides according to the above enumeration.

Particular preference is given in accordance with the invention to the embodiments in which the composite system has at least one scratch-resistant coating on a) or c), further preferably at least one scratch-resistant coating on a) and c). It is especially preferable in the context of the present invention when a) and c) each have a scratch-resistant coating on the respective outer layer sides thereof, i.e. the layer side which does not lead into the interior of the composite.

Preference is given in accordance with the invention to using scratch-resistant coatings which are thermally crosslinked or UV-crosslinked coating materials based on (meth)acrylates or silicones. These coating materials may further comprise scratch resistance-improving nanoparticles, for example based on silicon oxides. They often also comprise silicate pellets in order to achieve antiglare action. In the selection of the additional particles, however, very great care should be taken that these are sufficiently small that there is no light refraction, or that these particles have the same refractive index as the coating material used. The coating materials are preferably applied in dip-coating, spray-coating, spin-coating, etc.

Optionally, the polymer blend layer a) and the glass or polymer layer c), each of which has independently optionally been functionally coated on one or two sides, have optionally been joined to one another via one or more adhesive layers, glass layers and/or optical films, preferably one or more adhesive layers, more preferably at least one adhesive layer of an optical clear adhesive (OCA) or of a pressure-sensitive adhesive (PSA).

A composite system preferred in accordance with the invention has a haze value of <10%, preferably <5% (ISO 13803).

As already explained above, an inventive composite system is preferably a multilayer film. Moreover, it is especially preferable that this multilayer film is in the form of a cover, preferably of a display cover, or of a touchscreen, or of a glazing system, preferably of an automobile glazing system, or in the form of a part of a display, of a cover, preferably of a display cover or front pane of a display, or of a touchscreen or of a glazing system, preferably of an automobile glazing system. “Display” in the context of the present invention is understood to mean a device for displaying time-variable information.

Thus, the present invention further provides, as well as the inventive composite system, a display which comprises a composite system which is inventive as per the above description, especially according to one of the preferred embodiments.

In the context of the present invention, it is further preferable that this display, which comprises an inventive composite system, is an LCD, OLED or electrophoretic display.

In an inventive display, the polymer blend layer a) is preferably bonded to the layer c) beneath by means of an optical clear adhesive (OCA) or a pressure-sensitive adhesive (PSA). The selection of suitable OCAs or PSAs is generally familiar to those skilled in the art. This adhesive layer improves the mechanical stability of the overall display and reduces the reflection of light at the interfaces of the layers.

Likewise encompassed by the present invention is the use of a styrene-maleic anhydride (co)polymer,
wherein the proportion of repeat maleic anhydride units in the styrene-maleic anhydride (co)polymer B) is 10 to 30% by weight, preferably 15 to 28% by weight, more preferably 20 to 26% by weight, based on the total weight of the styrene-maleic anhydride (co)polymer B), and
wherein the styrene-maleic anhydride (co)polymer B) has been prepared from a monomer mixture comprising styrene, maleic anhydride and 0 to 50% by weight of vinyl monomers copolymerizable with styrene and/or maleic anhydride, based on the total weight of maleic anhydride in the styrene-maleic anhydride (co)polymer,

for reduction of the warpage of a display, of a display cover, of a touchscreen or of a glazing system, preferably of an automobile glazing system.

In the inventive use for reduction of the warpage of a display, of a display cover, of a touchscreen or of a glazing system, preferably of an automobile glazing system, the display, the display cover, the touchscreen or the glazing system, preferably the automobile glazing system, comprises a polymer or glass layer, preferably a thermoplastic polymer layer, more preferably a polycarbonate layer.

A further embodiment encompassed by the invention relates to the use of an inventive composite system as described above as a visual display element or in a visual display element.

Test Methods:

Mean Molecular Weight M_{w} (Weight Average) and Mean Molecular Weight Mₙ (Number Average):

The mean molecular weight M_{w} (weight average) and mean molecular weight Mₙ (number average) in the context of the present invention is determined via size exclusion chromatography (GPC) under the following conditions:

Columns 5 SDV columns from PSS (Mainz)

| No. | Type | Dimensions |
|---|---|---|
| precolumn | SDV LinL | 10μ 8 × 50 mm |
| 1 | SDV LinL | 10μ 8 × 300 mm |
| 2 | SDV LinL | 10μ 8 × 300 mm |
| 3 | SDV 100 Å | 10μ 8 × 300 mm |
| 4 | SDV 100 Å | 10μ 8 × 300 mm |

| | |
|---|---|
| Instruments: | Agilent 1100 series, UV detector G1314A |
| | Agilent 1100 series, RI detector G1362A |
| Column oven | T = 35° C. |
| Eluent | Tetrahydrofuran for polymer A) and comparative |
| | example II |
| | Tetrahydrofuran + 0.2% by vol. of trifluoroacetic |
| | acid for polymer B) and comparative example I |
| Flow rate | 1 ml/min |
| Injection volume | 100 μl |
| Detection | RI Equilibrated at 35° C. |
| Concentration | 2 g/l (in the case that Mw >10⁶: 1 . . . 0.25 g/l) |
| of the sample | |
| solution | |
| Standards | PMMA (e.g. from PSS (Mainz) for polymer A) and |
| | comparative example I + II |
| | polystyrene (e.g. from PSS (Mainz) for polymer B) |
| Concentration | 1 g/l (at Mw >10⁶: 0.5 g/l) |
| of the standard | |
| solution: | |
| Internal | o-dichlorobenzene → 1 drop/1.5 ml auto sample vial |
| standard | |

Warpage: 85° C., 85% r.h., 72 h (measurement of max. curvature with slide rule, 100×100 mm sample)

The warpage was measured in the context of the present invention on a sample having dimensions 100×100 mm, which were cut out of a coextruded sheet. The samples, which were approximately planar and flat after production, were placed in a climate-controlled cabinet lying on a grid at 85° C. and 85% relative humidity for 72 h, with the polymer blend layer a) or, in the comparative experiments conducted, the layer corresponding to the polymer blend layer a) at the top. After removal from the climate-controlled cabinet and the complete cooling of the samples at 23° C. for 24 h, the curvature (distance of the highest point from the flat base in mm) at the highest point was determined with a slide rule. In order to obtain meaningful values, at least double determinations were conducted in each case.

MVR: ISO 133 part 1; 230° C./3.8 kg

Heat distortion resistance: Vicat temperature; ISO 306-B50

Transmission: ISO 13468

Haze: ISO 13803

IR Method for Determination of the Proportion of Repeat Maleic Anhydride Units in the Styrene-Maleic Anhydride (Co)Polymer:

IR analysis of a chloroform solution of 15 mg of styrene-maleic anhydride (co)polymer in 1 ml of chloroform.

The examples which follow serve for further illustration and better understanding of the present invention, but do not restrict it or the scope thereof in any way.

### EXAMPLES

### Production of a Polymer Blend a) (for a Polymer Blend Layer a)) or Comparative Compositions

### Example

### Inventive

A modified PMMA according to the invention (=a polymer blend for the polymer blend layer a)) is prepared from:

50.00% by weight of a standard PMMA (corresponds to polymer A))

50.00% by weight of styrene-maleic anhydride (co)polymer (corresponds to polymer B)

The standard PMMA (=polymer A) is formed from 96% methyl methacrylate and 4% methyl acrylate. This PMMA is prepared based on DE 44 40 219 A1:

| | |
|---|---|
| 95.305% by weight | of methyl methacrylate |
| 4.000% by weight | of methyl acrylate |
| 0.310% by weight | of n-dodecyl mercaptan |
| 0.035% by weight | of dilauroyl peroxide |
| 0.030% by weight | of tert-butyl perisononanoate |
| 0.300% by weight | of stearyl alcohol |
| 0.020% by weight | of 2-(2′-hydroxy-5′-methylphenyl)benzotriazole |

The reactants are weighed into polyester bags, polymerized in a water bath and then heat-treated in a thermostated oven. Subsequently, the polymer is ground and devolatilized by means of an extruder.

Temperature profile for the polymerization in the water bath:

24 h 60° C.

Temperature profile in the thermostated oven:

6 h at 110° C.

The resultant molecular weight of the PMMA is M_{w}=149 000 g/mol measured by the GPC method.

The PMMA has a Vicat softening temperature VET (ISO 306-B50) of 105° C.

The styrene-maleic anhydride (co)polymer (=polymer B) is prepared by continuous polymerization of styrene and maleic anhydride with dibenzoyl peroxide in methyl ethyl ketone at 120° C. in a 100 l continuous stirred tank reactor with very good backmixing and by means of an anchor stirrer. This type of backmixed stirred tank is known from the prior art (e.g.: Chemische Reaktionstechnik [Chemical Reaction Technology], Georg Thieme Verlag 1987, p. 237-241.)

The polymer syrup in the outlet of the stirred tank reactor having a partial conversion of styrene and maleic anhydride is degassed continuously using a double-screw extruder with venting orifices and then pelletized in a pelletizer, and the product is subsequently analyzed for the polymer composition by IR spectroscopy. In the preparation of the styrene-maleic anhydride (co)polymer, it is ensured that the polymer content in the polymer syrup at the reactor outlet is about 28%, which means about 40% conversion of the total mass of the styrene and maleic anhydride used.

Specifically, a mixture of 9.2 kg/h of methyl ethyl ketone, 2.3 kg/h of maleic anhydride and 18.8 kg/h of styrene is fed continuously to the reactor at 23° C. Additionally fed continuously to the reactor is dibenzoyl peroxide as a polymerization initiator. The necessary mass flowrate of the dibenzoyl peroxide is calculated from the measured reactor temperature, which alters the stroke length of the metering pump for the dibenzoyl peroxide feed using a regulation system such that a constant reactor temperature of 110° C. can be maintained. In order to obtain a proportion of 23% by weight of repeat maleic anhydride units in the styrene-maleic anhydride (co)polymer, pellet samples are taken regularly and the composition is determined by means of IR spectroscopy. On the basis of the IR analysis, the proportion of maleic anhydride in the feed mixture is altered slightly, in order to obtain a proportion of 23% by weight of repeat maleic anhydride units in the styrene-maleic anhydride (co)polymer.

The IR spectroscopy analysis of the styrene-maleic anhydride (co)polymer, which is used for preparation of the polymer blend layer a) shows a proportion of 23% by weight of repeat maleic anhydride units and a proportion of 77% by weight of repeat styrene units in the styrene-maleic anhydride (co)polymer and a molecular weight of the styrene-maleic anhydride (co)polymer of M_{w}=86 500 g/mol and Mₙ=48 000 g/mol, measured by means of GPC. The Vicat softening temperature VET (ISO 306-B50) of the styrene-maleic anhydride (co)polymer is 146° C.

The constituents (polymer A and polymer B) are mixed with one another in a twin-screw extruder to produce the polymer blend a).

The measured proportion of repeat maleic anhydride units in the polymer blend a) is 11.5% by weight, based on the total weight of the polymer blend a).

The polymer blend a) has a Vicat softening temperature VET (ISO 306-B50) of 123° C.

### Comparative Example 1

The modified PMMA selected, having higher heat distortion resistance compared to standard PMMA, is a copolymer of methyl methacrylate, styrene and maleic anhydride. This copolymer is prepared based on DE 44 40 219 A1:

| | |
|---|---|
| 72.438% by weight | of methyl methacrylate |
| 16.000% by weight | of styrene |
| 11.000% by weight | of maleic anhydride |
| 0.360% by weight | of n-dodecyl mercaptan |
| 0.032% by weight | of tert-butyl perneodecanoate |
| 0.010% by weight | of teft-butyl perisononanoate |
| 0.150% by weight | of stearyl alcohol |
| 0.010% by weight | of 2-(2′-hydroxy-5′-methylphenyl)benzotriazole |

The reactants are weighed into polyester bags, polymerized in a water bath and then heat-treated in a thermostated oven. Subsequently, the polymer is ground and devolatilized by means of an extruder.

Temperature profile for the polymerization in a water bath:

12 h 52° C.

16 h 44° C.

Temperature profile in the thermostated oven:

6 h at 110° C.

The resultant molecular weight of the modified PMMA is M_{w}=145 000 g/mol measured by the GPC method.

The modified PMMA has a Vicat softening temperature VET (ISO 306-B50) of 122° C.

### Comparative Example 2

As a further comparison, a standard PMMA formed from 99% of methyl methacrylate, and 1% methyl acrylate is selected. This PMMA features a high heat distortion resistance. The copolymer is prepared based on DE 44 40 219 A1:

| | |
|---|---|
| 98.485% by weight | of methyl methacrylate |
| 1.000% by weight | of methyl acrylate |
| 0.290% by weight | of n-dodecyl mercaptan |
| 0.035% by weight | of dilauroyl peroxide |
| 0.030% by weight | of tert-butyl perisononanoate |
| 0.150% by weight | of stearyl alcohol |
| 0.010% by weight | of 2-(2′-hydroxy-5′-methylphenyl)benzotriazole |

The reactants are weighed into polyester bags, polymerized in a water bath and then heat-treated in a thermostated oven. Subsequently, the polymer is ground and devolatilized by means of an extruder.

Temperature profile for the polymerization in a water bath:

24 h 60° C.

Temperature profile in the thermostated oven:

6 h at 110° C.

The resultant molecular weight of the standard PMMA is M_{w}=152 000 g/mol measured by the GPC method.

The standard PMMA has a Vicat softening temperature VET (ISO 306-B50) of 109° C.

Production of a Composite

The polymer blend a) (inventive example), or the modified PMMA (comparative example 1), or the standard PMMA having high heat distortion resistance (comparative example 2), is laminated on one side using a die of a coextruder onto Makrolon® 2607 (polycarbonate layer, corresponding to layer c)). The lamination step is effected by coextrusion via an adapter die. The polycarbonate layer is 900 μm thick, while the polymer blend layer a) (inventive example), or the modified PMMA (comparative example 1), or the standard PMMA having high heat distortion resistance (comparative example 2) is 120 μm thick.

Parameters of the coextrusion experiments (the conditions were kept the same in all examples apart from the alterations mentioned):

Extruder manufacturer:

Main extruder, twin-screw extruder: Breyer (Singen)

Coextruder, single-screw extruder: Stork (Mörfelden-Walldorf)

Screw diameters:

Main extruder: 60 mm

Coextruder: 35 mm

Screw speed:

Main extruder: 47 rpm

Coextruder:

Inventive example: 82 rpm

Comparative example 1: 70 rpm

Comparative example 2: 55 rpm

Polymer throughput:

Main extruder: 60 kg/h

Coextruder: 7.2 kg/h

Draw-off speed of the plate: 1.9 m/min

Vacuum in the de-volatilization in both extruders 200 mbar+/−20 mbar

Temperatures (have been kept the same for all examples):

Barrel temperatures:

| | Main extruder (polycarbonate) | Coextruder (PMMA) |
|---|---|---|
| Heating zone 1 | 225 | 200 |
| Heating zone 2 | 280 | 250 |
| Heating zone 3 | 260 | 265 |
| Heating zone 4 | 259 | 265 |
| Heating zone 5 | 260 | 275 |
| Heating zone 6 | 260 | 275 |
| Heating zone 7 | 262 | 275 |
| Heating zone 8 | 260 | 275 |
| Heating zone 9 | 265 | — |

Die temperatures:

| | | | | | |
|---|---|---|---|---|---|
| 270 | 290 | 290 | 290 | 270 | PC side |
| | 270 | 276 | 271 | | PMMA side |

Results:

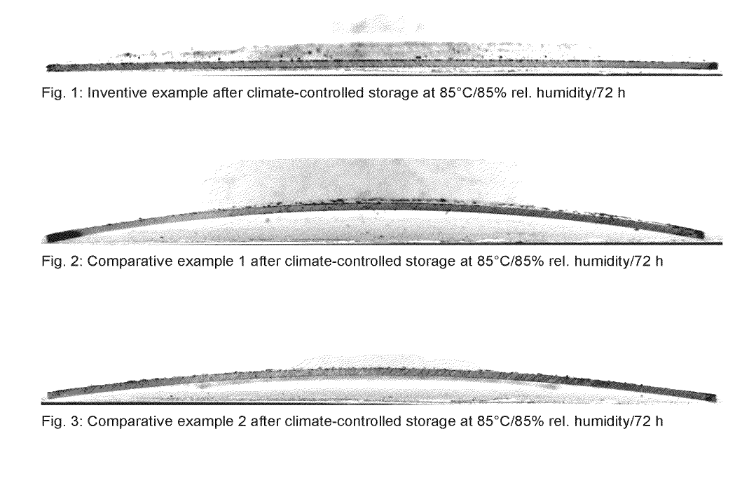

The results of the inventive example and of the comparative examples are compiled in the tables which follow. A clearly lower warpage is evident for the inventive composite of only 1.1 mm, in contrast to 3.8 and 3.7 mm for the comparative examples (FIGS. 1-3). More particularly, comparative example 1 also shows that the methyl methacrylate-styrene-maleic anhydride copolymer obtained has a higher heat distortion resistance than a standard PMMA having high heat distortion resistance in principle, but that the problem of low warpage of the laminate cannot be solved by the use of this copolymer.

The results further show that the values for transmission and haze of the inventive composite system or of the inventive multilayer film are not adversely affected compared to the corresponding values for comparative examples 1 and 2 within the accuracy of measurement.

TABLE 1
Profile of properties for polymer blend a) and the corresponding
comparative example compositions

| | | Comparative | Comparative | | |
|---|---|---|---|---|---|
| | Example | example 1 | example 2 | Method | Comment |
| MVR | 2.99 ml/10 min | 1.20 ml/10 min | 0.80 ml/10 min | ISO 1133 | |
| | | | | part 1 | |
| | | | | 230° C./3.8 kg | |
| Vicat | 123° C. | 122° C. | 109° C. | ISO 306 | |
| temperature | | | | | |
| (B/50) | | | | | |
| Transmission | 90.5% | 91.5% | 92.3% | ISO 13468 | 2 mm |
| | | | | | injection |
| | | | | | molding |

TABLE 2
Properties of the composite systems/multilayer films

| | | Comparative | Comparative | | |
|---|---|---|---|---|---|
| | Example | example 1 | example 2 | Parameter | Comment |
| Warpage | 1.1 mm | 3.8 mm | 3.7 mm | 85° C., 85%, | Measurement of max. |
| | | | | r.h., 72 h | curvature with slide rule |
| | | | | | 100 × 100 mm sample |
| Transmission | 90.20% | 90.20% | 90.40% | ISO 13468 | Measured over film |
| | | | | | thickness |
| Haze | 0.16% | 0.30% | 0.19% | ISO 13803 | Measured over film |
| | | | | | thickness |

1: A composite system, comprising:
a) a polymer blend layer comprising
A) a (meth)acrylate (co)polymer or a mixture of (meth)acrylate (co)polymers, and
B) a styrene-maleic anhydride (co)polymer;
b) optionally one or more adhesive layers, glass layers and/or optical films; and
c) a glass or polymer layer, preferably a polymer layer,
wherein:
a proportion of repeat maleic anhydride units in the styrene-maleic anhydride (co)polymer B) is 10 to 30% by weight, based on a total weight of the styrene-maleic anhydride (co)polymer B);
a proportion of repeat maleic anhydride units in the polymer blend layer a) is 1 to 27% by weight, based on a total weight of the polymer blend layer a);
the styrene-maleic anhydride (co)polymer B) is prepared from a monomer mixture comprising styrene, maleic anhydride and 0 to 50% by weight of vinyl monomers copolymerizable with styrene, maleic anhydride, or both, based on a total weight of the maleic anhydride in the styrene-maleic anhydride (co)polymer B); and
a) and c) are bonded to one another, or one or more layers b) bond the two layers a) and c) to one another.

2: The composite system as claimed in claim 1, wherein A) is formed of at least 30% by weight of repeat methyl methacrylate units, based on a total weight of A).

3: The composite system of claim 1, wherein a composition polymerized to form A) comprises one or more of the following monomers copolymerizable with methyl methacrylate and/or (meth)acrylates: alkyl(meth)acrylates, methyl acrylate, ethyl acrylate, butyl acrylate, cyclohexyl(meth)acrylate, norbornyl(meth)acrylate, (meth)acrylic acid, glutaric anhydride, styrene, maleic anhydride, n-isopropyl(meth)acrylamide, (meth)acrylamide, vinylcyclohexane, acrylonitrile, vinyl acetate and substituted styrenes.

4: The composite system of claim 1, wherein the styrene-maleic anhydride (co)polymer B) has a proportion of repeat styrene units of 55 to 90% by weight, based on the total weight of the styrene-maleic anhydride (co)polymer B).

5: The composite system of claim 1, wherein A) has a mean molecular weight of at least M_{w}=50 000 g/mol and/or B) has a mean molecular weight of at least M_{w}=40 000 g/mol.

6: The composite system of claim 1, wherein the polymer blend layer a) has a Vicat softening temperature VET (ISO 306-B50) of at least 110° C.

7: The composite system of claim 1, wherein the polymer blend layer a) further comprises UV stabilizers, UV absorbers, lubricants, antistats, flame retardants, additives for increasing scratch resistance, antioxidants, light stabilizers, organic phosphorus compounds, weathering stabilizers and/or plasticizers, each in a proportion of 0.001 to 5% by weight, based in each case on the total weight of the polymer blend layer a).

8: The composite system of claim 1, wherein a weight ratio of A) to B) ranges from 10:90 to 90:10.

9: The composite system of claim 1, wherein the glass or polymer layer c) is a polycarbonate layer.

10: The composite system of claim 1, wherein
the glass or polymer layer c) has a thickness ranging from 20 to 3000 μm, and/or
the polymer blend layer a) has a thickness ranging from 10 to 2000 μm.

11: The composite system of claim 1, wherein the polymer blend layer is applied to the glass or polymer layer c).

12: The composite system of claim 1, wherein the polymer blend layer a) and/or the glass or polymer layer c) has functional coatings on one or both sides.

13: The composite system of claim 12, wherein the functional coatings are scratch-resistant coatings.

14: The composite system of claim 1, wherein the composite system is a multilayer film in the form of a cover or of a glazing system or in the form of part of a display, of a cover, of a touchscreen or of a glazing system.

15: A display, comprising the composite system of claim 1.

16: A process for reducing warpage of a display, of a display cover, of a touchscreen or of glazing, the process comprising applying a layer comprising a styrene-maleic anhydride (co)polymer to a surface,
wherein:
a proportion of repeat maleic anhydride units in the styrene-maleic anhydride (co)polymer is 10 to 30% by weight, based on a total weight of the styrene-maleic anhydride (co)polymer; and
the styrene-maleic anhydride (co)polymer is prepared from a monomer mixture comprising styrene, maleic anhydride and 0 to 50% by weight of vinyl monomers copolymerizable with styrene and/or maleic anhydride, based on a total weight of the maleic anhydride in the styrene-maleic anhydride (co)polymer.

17: A visual display element, comprising the composite system of claim 1.
